(19) United States
(12) Patent Application Publication
(10) Pub. No.: US 2010/0134547 A1
(43) Pub. Date: Jun. 3, 2010

(54) PRINTING APPARATUS, PRINTING METHOD, AND PROGRAM

(75) Inventor: Kiyoaki Murai, Suwa-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/625,268

(22) Filed: Nov. 24, 2009

(30) Foreign Application Priority Data
Nov. 28, 2008 (JP) 2008-303765
Jul. 23, 2009 (JP) 2009-172395

(51) Int. Cl. B41J 29/38

(52) U.S. Cl. 347/14

(57) ABSTRACT

A printing apparatus includes: a first head which has a plurality of nozzles arranged at a predetermined pitch in a predetermined direction; a second head which has a plurality of nozzles arranged at the predetermined pitch in the predetermined direction in the predetermined direction and which is spaced from the first head by a predetermined distance in a direction intersecting the predetermined direction; and a controller which controls the first and second heads so that one of the first and second heads prints the contour of a character or a line image and both the first and second heads print a portion of the character or the line image other than the contour, when printing the character or the line image in the direction intersecting the predetermined direction.

### BACKGROUND

1. Technical Field

The present invention relates to a printing apparatus such as an ink jet printer and a printing method.

2. Related Art

In the past, as a printing apparatus having a plurality of heads to perform printing, there were known printing apparatuses disclosed in JP-A-2007-320110, JP-A-2002-103598, and JP-A-2006-326856.

The printing apparatus disclosed in JP-A-2007-320110 includes two heads 8 and 9 for ejecting ink, as shown in FIG. 10. The heads 8 and 9 have nozzles 81 and 91, respectively. The nozzles 81 and 91 are each arranged at a predetermined pitch. The two heads 8 and 9 are disposed in two rows in a direction intersecting a transport direction of a sheet. Moreover, the pitch of the nozzles of the first row head is deviated by ½ of a predetermined pitch from the pitch of the nozzles of the second row head.

The printing apparatus disclosed in JP-A-2002-103598 includes heads for ejecting black ink, yellow ink, magenta ink, and cyan ink, respectively, and performs printing by ejecting the ink onto a print medium sequentially from the plurality of heads.

The printing apparatus disclosed in JP-A-2006-326856 includes a first row print head and a second row print head for ejecting ink onto a print medium. The first row print head and the second row print head are disposed in zigzags.

In the printing apparatus disclose in JP-A-2007-320110, however, the first row head 8 and the second row head 9 are disposed at a predetermined interval in a transport direction of a sheet. Therefore, it takes certain time to eject ink from the nozzles 91 of the second row head 9 after the ink is ejected from the nozzles 81 of the first row head 8. For this reason, since the ink permeates into the sheet (print medium) and is dried during the certain time, it is considered that the ink is prevented from spreading. A method of disposing a heat for making ink dry more rapidly between the first and second row heads may be taken into consideration.

Taking this configuration into consideration, the printing apparatus disclosed in JP-A-2007-320110 can ensure the maximum amount of ink to be ejected from the nozzles even upon performing high speed printing. Accordingly, it is possible to realize the high speed printing without deteriorating print density.

In the printing apparatus disclosed in JP-A-2007-320110, however, disposition precision of the heads 8 and 9 becomes worse as the disposition distance between the first row head 8 and the second row head 9 is larger. This is because the first row head 8 and the second row head 9 are disposed at the predetermined interval in the transport direction of the sheet. For this reason, it is necessary to make an improvement in position precision between dots of the ink ejected from the nozzles 81 of the first row head 8 and the dots of the ink ejected from the nozzles 91 of the second row head 9.

FIGS. 11A and 11B are diagrams illustrating examples of characters printed by the printing apparatus disclosed in JP-A-2007-320110.

In FIGS. 11A and 11B, circles indicate the dots formed by ejecting the ink from the nozzles 81 of the head 8 and the nozzles 91 of the head 9. Numeral “1” in the circles represents the dots formed by the nozzles 81. Numeral “2” in the circles represents the dots formed by the nozzles 91.

FIG. 11A shows a good example of the position precision of the dots formed by ejecting the ink by the heads 8 and 9. In contrast, FIG. 11B shows a poor example of the position precision of the dots and shows that the precision of the dots of the ink cannot be ensured.

In such a circumstance, it is necessary to devise a printing apparatus capable of ensuring the position precision of the dots of ink upon printing a character or a line image, while performing high speed printing.

### SUMMARY

An advantage of some aspects of the invention is that it provides a printing apparatus capable of ensuring position precision of dots of ink upon printing a character or a line image, while ensuring high speed printing.

According to an aspect of the invention, there is provided a printing apparatus including: a first head which has a plurality of nozzles arranged at a predetermined pitch in a predetermined direction; a second head which has a plurality of nozzles arranged at the predetermined pitch in the predetermined direction in the predetermined direction and which is spaced from the first head by a predetermined distance in a direction intersecting the predetermined direction; and a controller which controls the first and second heads so that one of the first and second heads prints the contour of a character or a line image and both the first and second heads print a portion of the character or the line image other than the contour, when printing the character or the line image in the direction intersecting the predetermined direction.

Other aspects of the invention are apparent from the specification and the accompanying drawings.

### BRIEF DESCRIPTION OF THE DRAWINGS

The invention will be described with reference to the accompanying drawings, wherein like numbers reference like elements.

FIG. 1 is a front view illustrating the overall configuration of a printing apparatus according to an embodiment.

FIG. 2 is a plan view illustrating a configuration example of a line head.

FIG. 3 is a block diagram illustrating a configuration example of a control processing system of the printing apparatus according to the embodiment.

FIG. 4 is a flowchart for explaining an exemplary determination process.

FIGS. 5A and 5B are diagrams illustrating examples of printing.

FIG. 6 is a diagram for explaining a first example of a head assignment method.

FIG. 7 is a diagram for explaining a second example of the head assignment method.

FIG. 8 is a plan view illustrating a first other example of the line head.

FIG. 9 is a plan view illustrating a second other example of the line head.

FIG. 10 is a plan view illustrating the configuration example of a known line head.

FIGS. 11A and 11B are diagrams illustrating examples of known printing.

FIG. 12 is a plan view illustrating a third other example of the line head.

### DESCRIPTION OF EXEMPLARY EMBODIMENTS

At least the following aspects are apparent from the description of the specification and the accompanying drawings.

According to an aspect of the invention, there is provided a printing apparatus including: a first head which has a plurality of nozzles arranged at a predetermined pitch in a predetermined direction; a second head which has a plurality of nozzles arranged at the predetermined pitch in the predetermined direction in the predetermined direction and which is spaced from the first head by a predetermined distance in a direction intersecting the predetermined direction; and a controller which controls the first and second heads so that one of the first and second heads prints the contour of a character or a line image and both the first and second heads print a portion of the character or the line image other than the contour, when printing the character or the line image in the direction intersecting the predetermined direction.

In the printing apparatus having the configuration, the first head may be disposed on the upstream side of the second head in a transport direction of a print medium transported in the direction intersecting the predetermined direction. The contour of the character or the line image may be printed by the first head.

In the printing apparatus having the configuration, the controller may allow a contour detecting unit to detect the contour of the character or the line image, when printing the character or the line image. The contour of the character or the line image may be printed by one of the first and second heads, when the contour detecting unit has detected the contour of the character or the line image.

In the printing apparatus having the configuration, the nozzles of the first head and the nozzles of the second head may eject the same color ink.

In the printing apparatus having the configuration, the first and second heads may be selectively used in accordance with a predetermined rule to print the character or the line image, when the portion of the character or the line image other than the contour is printed.

The printing apparatus having the configuration may further include a drying mechanism which accelerates the drying of ink and which is disposed between the first and second heads.

In the printing apparatus having the configuration, the first and second heads may include first and second heads for performing the printing with a first color and first and second heads for performing the printing with a second color. The first head for performing the printing with the first color, the first head for performing the printing with the second color, the second head for performing the printing with the first color, and the second head for performing the printing with the second color may be arranged in this order in the transport direction of the print medium transported in the direction intersecting the predetermined direction.

In the printing apparatus having the configuration, the first and second heads may include first and second heads for performing the printing with a first color and first and second heads for performing the printing with a second color. The first head for performing the printing with the first color, the second head for performing the printing with the first color, the first head for performing the printing with the second color, and the second head for performing the printing with the second color may be arranged in this order in the transport direction of the print medium transported in the direction intersecting the predetermined direction.

In the printing apparatus having the configuration, the first and second heads may include first and second heads for performing the printing with a first color and first and second heads for performing the printing with a second color. A distance between the first and second heads for performing the printing with the first color and a distance between the first and second heads for performing the printing with the second color may be larger than a distance between the second head for performing the printing with the first color and the first head for performing the printing with the second color.

The printing apparatus having the configuration may further include a head unit which includes the first and second heads for each fluid ink color. The head units may be disposed so as to overlap with each other in the predetermined direction.

According to another aspect of the invention, there is provided a printing method performed by a printing apparatus including a first head which has a plurality of nozzles arranged at a predetermined pitch in a predetermined direction and a second head which has a plurality of nozzles arranged at the predetermined pitch in the predetermined direction in the predetermined direction and which is spaced from the first head by a predetermined distance in a direction intersecting the predetermined direction. The printing method includes: detecting the contour of the character or the line image, when the character or the line image is printed in the direction intersecting the predetermined direction; printing the detected contour by one of the first and second heads; and printing a portion of the character or the line image other than the contour by both the first and second heads.

According to still another aspect of the invention, there is provided a program which controls a printing apparatus including a first head which has a plurality of nozzles arranged at a predetermined pitch in a predetermined direction and a second head which has a plurality of nozzles arranged at the predetermined pitch in the predetermined direction in the predetermined direction and which is spaced from the first head by a predetermined distance in a direction intersecting the predetermined direction. The program causes a computer to execute:

detecting the contour of the character or the line image, when the character or the line image is printed in the direction intersecting the predetermined direction; printing the detected contour by one of the first and second heads; and printing a portion of the character or the line image other than the contour by both the first and second heads.

### Embodiment

Hereinafter, an exemplary embodiment of the invention will be described with reference to the drawings.

### Overall Configuration of Printing Apparatus

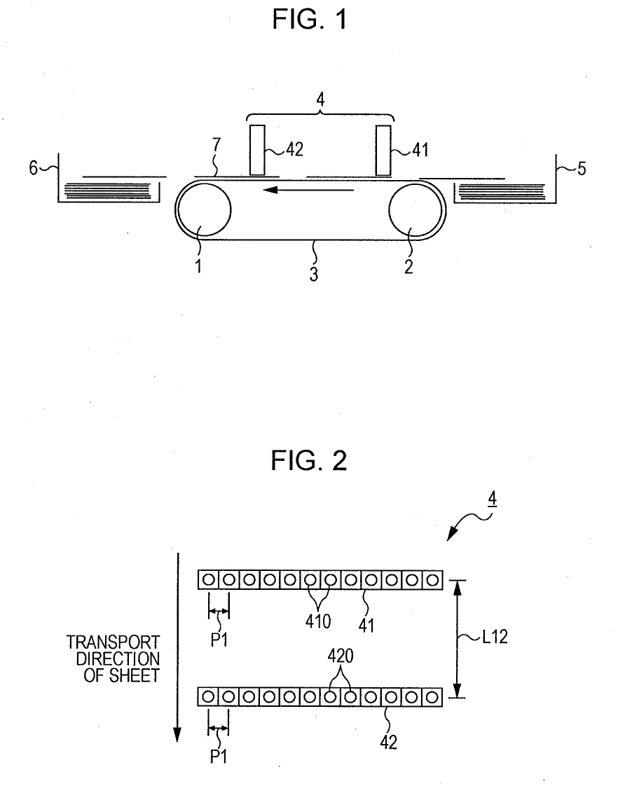

The overall configuration of a printing apparatus according to this embodiment will be described with reference to FIG. 1.

The printing apparatus according to this embodiment is a line printer shown in FIG. 1, for example. The printing apparatus includes transport rollers 1 and 2, a belt 3, a line head 4, a sheet supply unit 5, and a sheet discharge unit 6.

The transport rollers 1 and 2 are suspended on the belt 3. When a transport motor (not shown) rotates, the transport rollers 1 and 2 rotate and thus the belt 3 moves round. Therefore, a sheet 7 which is an example of a print sheet is transported on the belt 3. The line head 4 which performs printing by ejecting ink droplets onto the print sheet 7 being transported on the belt 3 is disposed at a predetermined position above the belt 3, as described below.

The sheet supply unit 5 disposed at one end of the belt 3 supplies the sheet 7 onto the belt 3 one by one. The sheet discharge unit 6 disposed at the other end of the belt 3 discharges the sheet 7 on which desired printing is completely performed by the line head 4 while the sheet 7 is transported on the belt 3.

### Configuration of Line Head

FIG. 2 is a diagram illustrating a configuration example of the line head 4 shown in FIG. 1.

In the line head 4, a first row head 41 and a second row head 42 are disposed in order at a predetermined interval L12 in a transport direction of a sheet, as shown in FIGS. 1 and 2. The first row head 41 is disposed on the upstream side of the second row head 42 in the transport direction of the sheet. The same ink is ejected from the nozzles of the first row head 41 and the nozzles of the second row head 42. For example, black ink is ejected.

The first row head 41 includes a plurality of nozzles 410 serving as a print element for ejecting ink. The nozzles 410 are arranged at a predetermined pitch P1 in a direction (corresponding to a predetermined direction) intersecting the transport direction of the sheet. Likewise, the second row head 42 includes a plurality of nozzles 420 serving as a print element ejecting ink. The nozzles 420 are arranged at the same pitch as the pitch P1 in the direction intersecting the transport direction of the sheet. As shown in FIG. 2, the plurality of nozzles 410 of the first row head 41 is arranged so that the phase thereof is same as that of the plurality of nozzles 420 of the second row head 42.

### Configuration of Control Processing System of Printing Apparatus

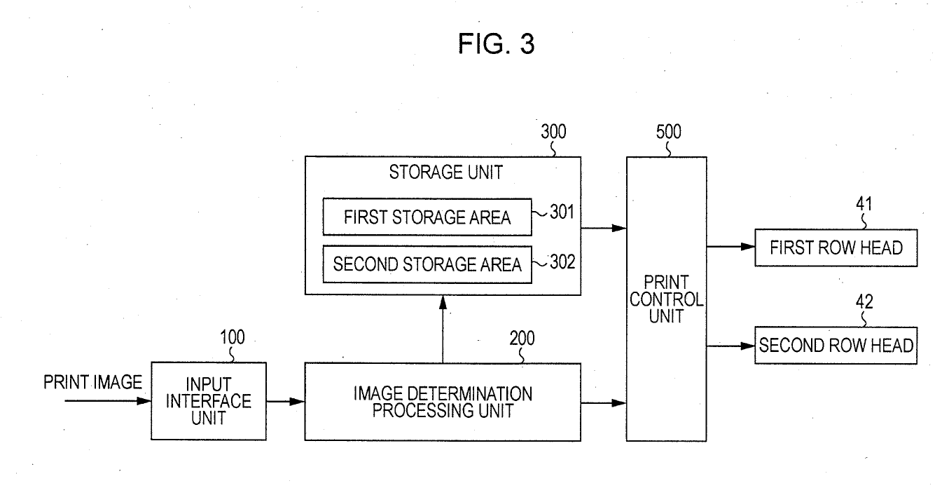

Next, the functional configuration of a control processing system of the printing apparatus according to this embodiment will be described with reference to FIG. 3.

The printing apparatus according to this embodiment controls the heads 41 and 42 so that one of the first row head 41 and the second row head 42 prints the contour of a character or a line image when a print image is the character or the line image and so that both the first row head 41 and the second row head 42 print a portion (inside) other than the contour of the character and a portion (inside) other than the contour of the line image.

The control processing system of the printing apparatus according to this embodiment includes an input interface unit 100, an image determination processing unit 200, a storage unit 300, and a print control unit 500, as shown in FIG. 3. The control processing system controls the printing (controls the ejection of ink) of the heads 41 and 42.

Here, the print image which is printed by the printing apparatus according to this embodiment includes a character, a line image (figure or the like), and or the like. In this embodiment, the determination processing unit 200 is the constituent element of the printing apparatus, but is not necessarily the constituent element.

The input interface unit 100 acquires the print image from a computer or the like and outputs the acquired print image to the image determination processing unit 200.

The image determination processing unit 200 performs a determination process on the acquired print image, as described below, assigns printing to the heads 41 and 42 to all pixels in accordance with this determination, and generates print data (nozzle control data indicating whether to eject ink) used to eject the ink for every nozzle of the assigned heads. The generated print data are stored in the storage unit 300.

The image determination processing unit 200 includes a CPU, a RAM, and a ROM. The CPU executes the determination process, which is described below, in accordance with a program stored in advance in the ROM. Upon performing this determination process, the RAM is used as a work memory.

The storage unit 300 includes a first storage area 301 and a second storage area 302 and stores the print data generated in the image determination processing unit 200. The print data used to eject the ink from the nozzles 410 of the first row heads 41 are stored in the first storage area 301. The print data used to eject the ink from the nozzles 420 of the second row heads 42 are stored in the second storage area 302.

The print control unit 500 reads the print data stored in the storage unit 300 at predetermined time and controls the ejection of the ink from the nozzles 410 of the head 41 or the nozzles 420 of the head 42 on the basis of the read print data.

### Exemplary Determination Process

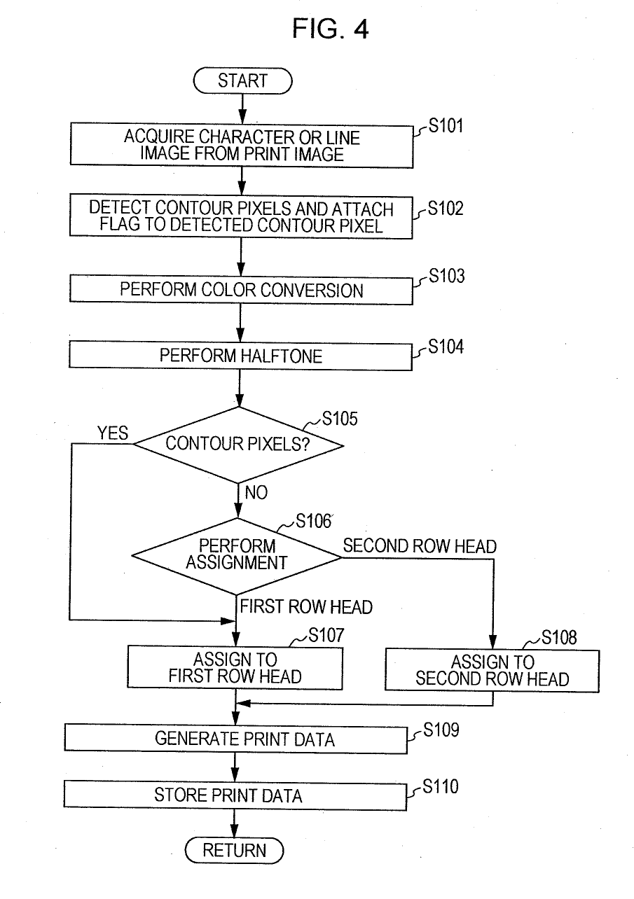

Next, an exemplary determination process of the image determination processing unit 200 of the printing apparatus according to this embodiment will be described with reference to FIG. 4.

The outline of the determination process is as follows.

When the print image to be printed by the line head 4 is a character or a line image (figure or the like), the contour of the character or the line image is detected, the contour of the character or the line image is printed by a predetermined one (the head 41 in the example of FIG. 4) of the first row head 41 and the second row head 42, and the portion other than the contour is printed by both the first row head 41 and the second row head 42.

Hereinafter, the exemplary determination process will be described in more detail.

In step S101, the line head 4 acquires a character or a line image (such as a figure), which is printed by the line head 4, as the print image.

In step S102, the pixel (contour pixel) of the contour of the acquired character or line image is detected in accordance with a predetermined rule and a flag is attached to the detected contour pixel. The reason for attaching the flag is to distinguish the contour from the portion (inside) other than the contour.

Here, the contour pixel to which the flag is attached is at least one pixel. Alternatively, a plurality of the pixels (for example, five pixels) may be used.

In step S103, a color conversion process is performed. In this process, the data of the acquired print image is converted into the data of a CMKY format since the acquired print image has RGB image data. In step S104, a process associated with a halftone (middle tone) is performed. The reason for performing this process is to execute the binarization of the data.

In step S105, it is determined whether the pixels of a printing target character or line image are the contour pixels.

When it is determined in step S105 that the pixels of the character or the line image are the contour pixels, the process proceeds to step S107. Then, the printing of the contour pixels is assigned to the first row head 41 so that the printing of the contour pixels is performed by the first row head 41.

Alternatively, when it is determined in step S105 that the pixels of the character or the line image are not the contour pixels, the process proceeds to step S106. In step S106, an assignment process of assigning the printing to the two heads 41 and 42 is performed to allow the first row head 41 and the second row head 42 not to print the contour pixels of the character or the line image but to print the pixels of the inside. This assignment process is performed in accordance with a predetermined rule, as described below.

As a result of the assignment process, the printing of the inside other than the contour pixels of the character or the line image is assigned to the first row head 41 and the second row head 42 (steps S107 and S108).

In step S109, print data (nozzle control data representing whether to eject the ink) used to eject the ink from the nozzles of the heads 41 and 42 to which the printing is assigned are generated on the basis of the assignment of the heads 41 and 42 in steps S107 and S108.

In step S110, the generated print data are stored in the storage unit 300. The print data used to eject the ink from the nozzles 410 of the first row head 41 are stored in the first storage area 301. The print data used to eject the ink from the nozzles 420 of the second row head 42 are stored in the second storage area 302.

The print control unit 500 reads the print data stored in the storage unit 300 at a predetermined time and controls the ejection of the ink from the nozzles 410 of the head 41 or the nozzles 420 of the head 42 on the basis of the read print data.

### Example of Printing

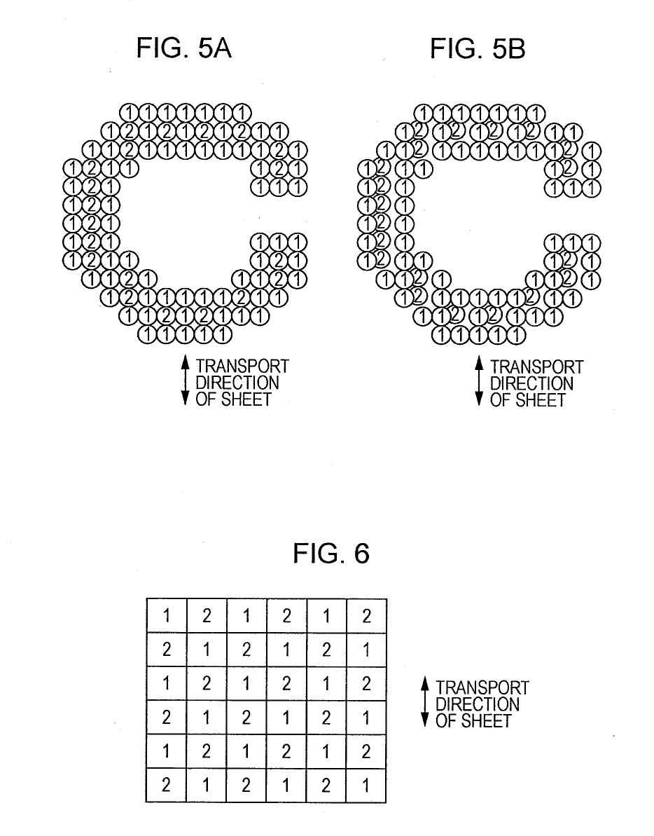

FIGS. 5A and 5B are diagrams illustrating the examples of printing.

In FIGS. 5A and 5B, circles indicate dots formed by ejecting the ink from the nozzles 410 of the head 41 and the nozzles 420 of the head 42. In addition, Numeral “1” in the circles represents the dot formed by the nozzle 410 and Numeral “2” in the circles represent the dot formed by the nozzle 420.

FIG. 5A shows a case where the position precision of the dots formed by ejecting the ink is good since the disposition precision of the heads 41 and 42 is good. FIG. 5B shows a case where the position precision of the dots is poor since the disposition precision is not sufficiently achieved.

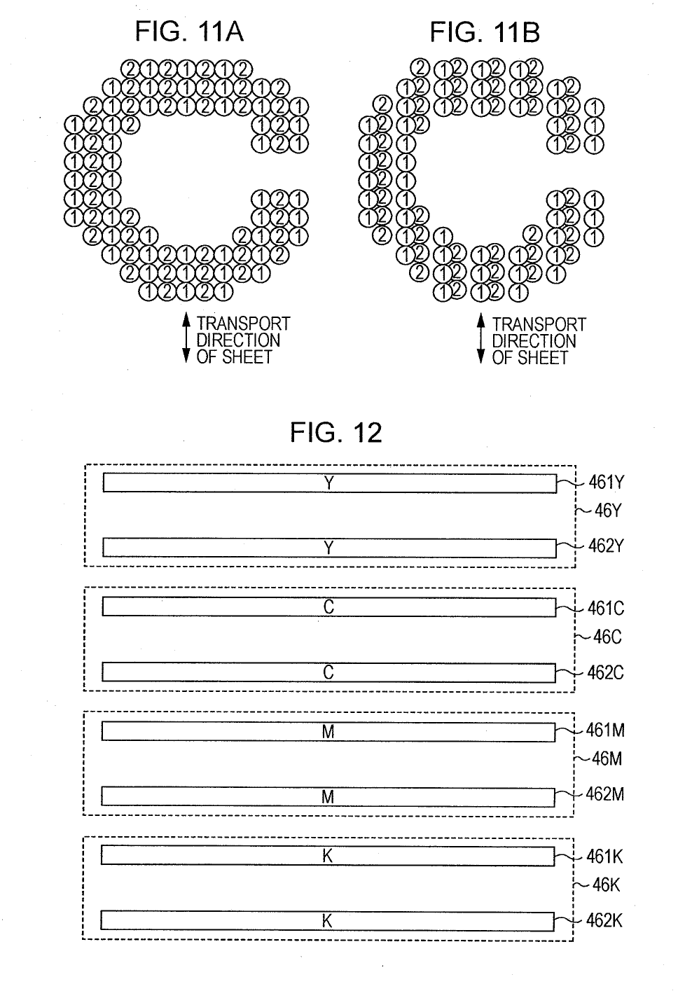

Comparing the example of the printing in FIGS. 5A and 5B to the example of the printing in FIGS. 11A and 11B, there is little great difference between the technique according to this embodiment and the known technique when the position precision of the dots formed by ejecting the ink is good owing to the good position precision of two heads (see FIGS. 5A and 11A).

In this embodiment, however, even when the position precision of the dots formed by ejecting the ink is poor since the disposition precision of the heads 41 and 42 is not sufficiently achieved, the good contour precision of the character is achieved since one of the heads 41 and 42 prints the contour of the character. Accordingly, deterioration in the print quality as in the known technique is not caused in this embodiment (see FIGS. 5B and 11B).

### Methods of Assigning Heads

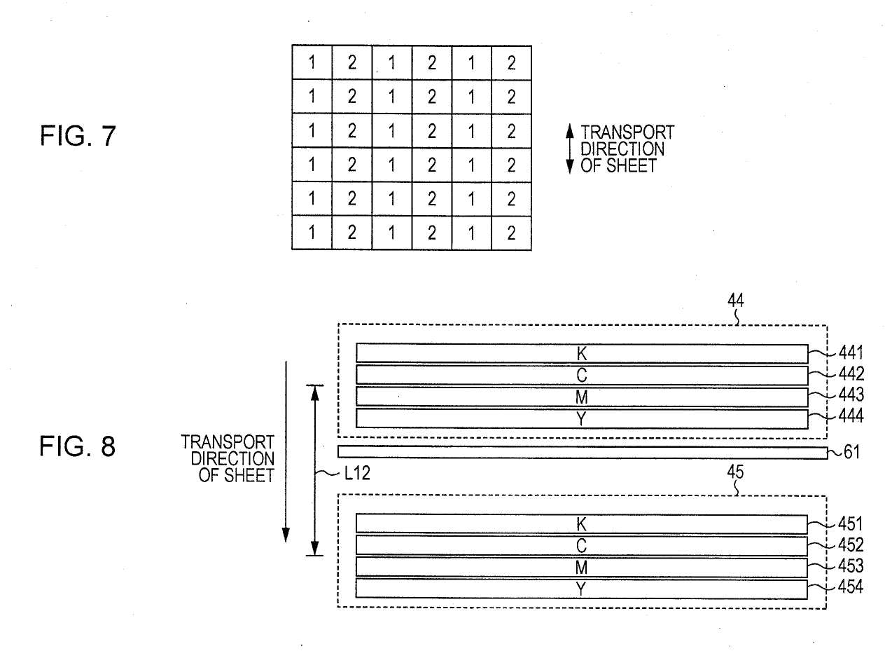

Next, the method of assigning the printing of the pixels of the inside of the character or the line image other than the contour pixels to the two heads 41 and 42 in step S106 of FIG. 4 will be described with reference to FIGS. 6 and 7.

(A) FIG. 6 is a diagram for explaining a first example of the assignment method.

The first example shows a method of assigning the printing in advance to the heads used to print the inside of the character or the like other than the contour in pixel unit, as shown in FIG. 6. In FIG. 6, each square indicates one pixel. Numeral “1” in the square means that the pixel is printed by the first row head 41. Numeral “2” in the square means that the pixel is printed by the second row head 42.

(B) FIG. 7 is a diagram for explaining a second example of the assignment method.

As shown in FIG. 7, the second example shows a method of assigning the printing in advance to the heads used to print the inside of the character or the like other than the contour in a plurality of pixel units. In FIG. 7, each square indicates one pixel. The meaning of Numerals in the square is the same as that of FIG. 6.

Here, the second example is applied to the examples of the printing in FIGS. 5A and 5B.

(C) In the examples of FIGS. 6 and 7, each half of the printing is assigned to each of the first row head 41 and the second row head 42. However, 60% of the printing may be assigned to the first row head 41 and the remainder 40% of the printing may be assigned to the second row head 42. In this way, since a lot of ink can be ejected faster from the first row head 41, it is possible to dry the printed character or the printed line image rapidly even when the area of the character or the line image is relatively large.

### Other Configurations of Line Head

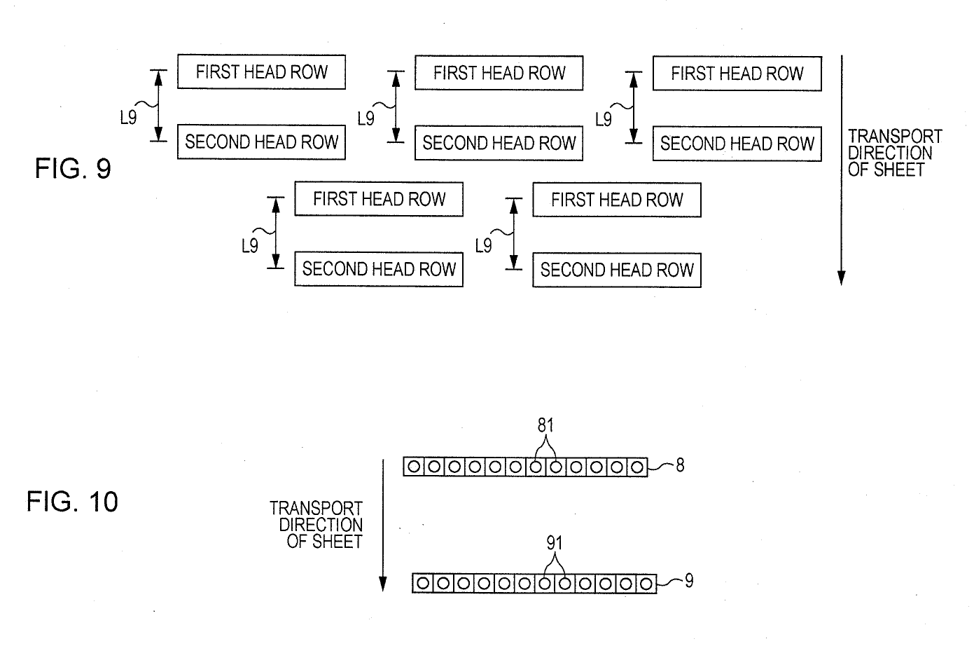

FIGS. 8 and 9 are diagrams illustrating other configuration examples of the line head.

(A) FIG. 8 shows a first other example of the line head.

In the first other example, as the line head capable of performing color printing of four colors, there are provided a first row head unit 44 and a second row head unit 45, which are arranged in parallel in the transport direction of the sheet.

The first row head unit 44 and the second row head unit 45 are disposed at a predetermined interval L12 in the transport direction of the sheet, as shown in FIG. 8.

The first row head unit 44 includes a head 441 for ejecting black (K) ink, a head 442 for ejecting cyan (C) ink, a head 443 for ejecting magenta (M) ink, and a head 444 for ejecting yellow (Y) ink.

Likewise, the second row head unit 45 includes heads 451 to 454 for ejecting black ink, cyan ink, magenta ink, and yellow ink, respectively.

The nozzles of each head of the first row head unit 44 are arranged so as to have the same phase as that of the nozzles of each head of the second row head unit 45. This configuration is the same as that of the first row head 41 and the second row head 42 in FIG. 2.

A drying mechanism 61 for accelerating the drying of the ink may be disposed between the first row head unit 44 and the second row head unit 45. The drying mechanism 61 may be an apparatus such as a metal halide lamp or an LED for radiating ultraviolet rays, when the ink is ultraviolet curing ink (UV ink), for example. Alternatively, there may be provided a blowing mechanism for blowing wind to dry the ink. Alternatively, there may be provided a heating mechanism for accelerating the drying of the ink.

(B) FIG. 9 shows a second other example of the line head.

In the second other example, first head rows and second head rows are arranged at an interval L9 in the transport direction of the sheet. The head rows are arranged in zigzags in a direction intersecting the transport direction of the sheet. On the whole, the head rows form a line head. This embodiment is applicable to the printing apparatus having such a configuration of the line head.

In this embodiment, the line head is configured by the heads 41 and 42 arranged in two rows, as in FIG. 2. The heads 41 and 42 are arranged at the same pitch P1 so that the phase of the nozzles is the same. The contour of the character or the line image is printed by each one of the heads 41 and 42 to print the contour with high precision. The inside other than the contour of the character or the line image is printed by both the heads 41 and 42.

In this embodiment, it is possible to print the character or the line with high precision. Moreover, it is possible to print the character or the line at a high speed without lowering the print density.

In this embodiment, since the contour of the character or the like is printed by the first head disposed on the upstream side in the transport direction, the ink ejected onto the contour of the character or the like permeates into the sheet (print medium) or is dried until the print medium is transported up to the position of the second head. Accordingly, it is possible to prevent the ink from spreading.

(C) FIG. 12 is a plan view illustrating a third other example of the line head. In the third other example, a first row head and a second row head constitute one head unit in every ink color. For example, a first row head 461Y and a second row head 462Y for yellow ink constitute one head unit 46Y. In the head unit, the first row head 461Y and the second row head 462Y are spaced from each other in the transport direction of the sheet.

The head units are arranged in order of yellow ink, cyan ink, magenta ink, black ink from the upstream side in the transport direction of the sheet. The adjacent head units are disposed in the neighborhood of one another. Accordingly, a distance between the first row head 461Y and the second row head 462Y for yellow ink is larger than a distance between the second row head 462Y for yellow ink and a first row head 461C for cyan ink.

In the configuration of each head unit constituted by the first and second row heads, each ink can be landed to form the portion other than the contour of the character or the like after the contour is formed. That is, since the order of landing the ink can normally be made the same, it is possible to improve color uniformity.

In this embodiment, four colors, cyan, magenta, yellow, and black have been used as the ink colors. However, ink with low density may be added to lower granularity. In order to increase the color gamut, ink different from the four colors such as orange or green may be added. Alternatively, in order to improve gloss or improve a friction-resistant property of a printing unit, achromatic color ink may be added. Moreover, a head ejecting only mono-color ink for white-and-black printing may be used.

### Modified Examples

(1) In the examples of the printing in FIGS. 5A and 5B, the width of the contour which is printed by the first row head 41 is formed with one dot. However, the width of the contour may be formed with a plurality of dots. Accordingly, the width of the contour is formed with at least one dot.

In the examples of the printing in FIGS. 5A and 5B, all the pixels of the inside other than the contour are printed. However, other than printing all the pixels, it is possible not to print some of the pixels. In this case, the inside other than the contour is printed in accordance with a predetermined rule.

(2) In the above-described embodiment, the ink is landed onto the sheet 7, but any medium (print medium) onto which ink can be landed can be used. Accordingly, in printing performed on a print medium such as cloth, it is possible to ensure position precision of dots.

(3) In the above-described embodiment, the relative position of the line head 4 and the print medium is changed by transporting the sheet 7. However, any one of the line head 4 and the sheet 7 may be moved, as long as the relative position of the line head 4 and the print medium is changed. The line head 4 may be moved relative to the print medium to correspond to a change in the relative position by the transport of the sheet as in the above-described embodiment. Alternatively, both the line head 4 and the print medium may be moved.

(4) In the above-described embodiment, the program associated with the determination process has been executed in the determination processing unit 200. However, the program may be executed by a computer. In this case, the program is supplied in a form stored in a computer readable record medium. As such a recording medium, there are used a variety of computer readable mediums such as a flexible disk, a CD-ROM, a magneto-optical disk, an IC card, a ROM cartridge, a punch card, a printing product in which signs such as barcode is printed, an internal storage device (a memory such as a RAM or a ROM) of a computer, and an external storage device of a computer.

(5) In the above-described embodiment, the input interface 100, the image determination processing unit 200, the storage unit 300, and the print control unit 500 are included in the printing apparatus, but the functions thereof may be realized in an image control apparatus such as a personal computer (PC) or a server. Likewise, steps S101 to S110 in FIG. 4 are executed in the printer, but step S101 to any one step or steps S101 to S110 may be executed by the image control apparatus.

(6) In the above-described embodiment and FIG. 4, the printing is assigned to the first row head 41, when it is determined in step S105 that the pixels of the character or the line image are the contour pixels. However, the printing may be assigned to the second row head 42 instead of the first row head 41.

(7) In the above-described embodiment, the two heads, the first row head 41 and the second row head 42 have been described. However, the line head 4 may be constituted by three or more heads. In this case, the dots for the contour pixels are formed by ejecting ink from one head.

(8) The invention may be modified in various forms without departing from the gist of the invention.

The entire disclosure of Japanese Patent Application No. 2008-303765, filed Nov. 28, 2008 and 2009-172395, filed Jul. 23, 2009 are expressly incorporated by reference herein.

What is claimed is:

1. A printing apparatus comprising:
a first head which has a plurality of nozzles arranged at a predetermined pitch in a predetermined direction;
a second head which has a plurality of nozzles arranged at the predetermined pitch in the predetermined direction in the predetermined direction and which is spaced from the first head by a predetermined distance in a direction intersecting the predetermined direction; and
a controller which controls the first and second heads so that one of the first and second heads prints the contour of a character or a line image and both the first and second heads print a portion of the character or the line image other than the contour, when printing the character or the line image in the direction intersecting the predetermined direction.

2. The printing apparatus according to claim 1,
wherein the first head is disposed on the upstream side of the second head in a transport direction of a print medium transported in the direction intersecting the predetermined direction, and
wherein the contour of the character or the line image is printed by the first head.

3. The printing apparatus according to claim 1,
wherein the controller allows a contour detecting unit to detect the contour of the character or the line image, when printing the character or the line image, and
wherein the contour of the character or the line image is printed by one of the first and second heads, when the contour detecting unit has detected the contour of the character or the line image.

4. The printing apparatus according to claim 1, wherein the nozzles of the first head and the nozzles of the second head eject the same color ink.

5. The printing apparatus according to claim 1, wherein the first and second heads are selectively used in accordance with a predetermined rule to print the character or the line image, when the portion of the character or the line image other than the contour is printed.

6. The printing apparatus according to claim 1, further comprising a drying mechanism which accelerates the drying of ink and which is disposed between the first and second heads.

7. The printing apparatus according to claim 1,
wherein the first and second heads include first and second heads for performing the printing with a first color and first and second heads for performing the printing with a second color, and
wherein the first head for performing the printing with the first color, the first head for performing the printing with the second color, the second head for performing the printing with the first color, and the second head for performing the printing with the second color are arranged in this order in the transport direction of the print medium transported in the direction intersecting the predetermined direction.

8. The printing apparatus according to claim 1,
wherein the first and second heads include first and second heads for performing the printing with a first color and first and second heads for performing the printing with a second color, and
wherein the first head for performing the printing with the first color, the second head for performing the printing with the first color, the first head for performing the printing with the second color, and the second head for performing the printing with the second color are arranged in this order in the transport direction of the print medium transported in the direction intersecting the predetermined direction.

9. The printing apparatus according to claim 1,
wherein the first and second heads include first and second heads for performing the printing with a first color and first and second heads for performing the printing with a second color, and
wherein a distance between the first and second heads for performing the printing with the first color and a distance between the first and second heads for performing the printing with the second color are larger than a distance between the second head for performing the printing with the first color and the first head for performing the printing with the second color.

10. The printing apparatus according to claim 8, further comprising:
a head unit which includes the first and second heads for each fluid ink color,
wherein the head units are disposed so as to overlap with each other in the predetermined direction.

11. A printing method performed by a printing apparatus including a first head which has a plurality of nozzles arranged at a predetermined pitch in a predetermined direction and a second head which has a plurality of nozzles arranged at the predetermined pitch in the predetermined direction in the predetermined direction and which is spaced from the first head by a predetermined distance in a direction intersecting the predetermined direction, the printing method comprising:
detecting the contour of the character or the line image, when the character or the line image is printed in the direction intersecting the predetermined direction;
printing the detected contour by one of the first and second heads; and
printing a portion of the character or the line image other than the contour by both the first and second heads.

12. A program which controls a printing apparatus including a first head which has a plurality of nozzles arranged at a predetermined pitch in a predetermined direction and a second head which has a plurality of nozzles arranged at the predetermined pitch in the predetermined direction in the predetermined direction and which is spaced from the first head by a predetermined distance in a direction intersecting the predetermined direction, the program causing a computer to execute:
detecting the contour of the character or the line image, when the character or the line image is printed in the direction intersecting the predetermined direction;
printing the detected contour by one of the first and second heads; and
printing a portion of the character or the line image other than the contour by both the first and second heads.
